(19) United States
(12) Patent Application Publication
(10) Pub. No.: US 2022/0092803 A1
(43) Pub. Date: Mar. 24, 2022

(54) PICTURE RENDERING METHOD AND APPARATUS, TERMINAL AND CORRESPONDING STORAGE MEDIUM

(71) Applicant: KANDAO TECHNOLOGY CO., LTD., Guangdong (CN)

(72) Inventors: Sijie DING, Shenzhen (CN); Fangqi GAO, Shenzhen (CN)

(73) Assignee: KANDAO TECHNOLOGY CO., LTD., Guangdong (CN)

(21) Appl. No.: 17/421,387

(22) PCT Filed: Jan. 9, 2020
(86) PCT No.: PCT/CN2020/071257

§ 371 Date: Jul. 8, 2021

(30) Foreign Application Priority Data
Jan. 10, 2019 (CN) 201910024117.6

(51) Int. Cl. G06T 7/50; G06T 5/50; G06T 7/11; G06T 5/00

(52) U.S. Cl. CPC G06T 7/50; G06T 5/50; G06T 2207/20221; G06T 5/002; G06T 7/11

(57) ABSTRACT

The present disclosure provides a panoramic image stitching method, including the steps of acquiring a partial panoramic image taken by each lens; acquiring a first equirectangular rectangular projection graph of each partial panoramic image; performing rotation transformation on the first equirectangular rectangular projection graph of each partial panoramic image to obtain a second equirectangular rectangular projection graph; and adjusting stitching positions of adjacent second equirectangular rectangular projection graphs, and performing stitching operation on the second equirectangular rectangular projection graphs according to the adjusted stitching positions.

### BACKGROUND

### Technical Field

The present invention relates to the technical field of image processing, in particular to a picture rendering method and apparatus, a terminal and a corresponding storage medium.

### Description of Related Art

With the development of science and technology, people's requirements on the quality of a video picture become higher and higher. For example, a user hopes that the definition of a shot photo becomes higher and higher, and the picture rendering effect becomes more and more realistic.

However, there be often near objects and distant objects in an existing video picture frame. When the near objects and the distant objects in the video picture frame are required to be rendered at the same time, the relatively poor picture rendering effect of the video picture frame having the near objects and the distant objects at the same time is caused due to different focal distances of the near objects and the distant objects.

Therefore, it is necessary to provide a picture rendering method and apparatus to solve problems existing in the prior art.

### SUMMARY

Embodiments of the present invention provide a picture rendering method and apparatus having a better picture rendering effect for near objects and distant objects in a picture so as to solve the technical problem of relatively poor picture rendering effect of a video picture frame having near objects and distant objects at the same time in an existing picture rendering method and apparatus.

An embodiment of the present invention provides a picture rendering method, comprising:

acquiring a target picture, and acquiring a picture disparity map of the target picture by using a stereo matching algorithm;

determining a pixel depth in the target picture according to a pixel brightness in the picture disparity map;

acquiring a target image in the target picture, and dividing the target picture into a primary rendering region and a plurality of secondary rendering regions based on the pixel depth of the target picture and a target image depth of the target picture;

performing picture rendering on the primary rendering region and the plurality of secondary rendering regions according to difference values of pixel depths corresponding to the secondary rendering regions and a pixel depth corresponding to the primary rendering region; and

synthesizing the picture-rendered primary rendering region and secondary rendering regions to generate a rendered target picture.

In the picture rendering method provided by the present invention, the step of determining a pixel depth in the target picture according to a pixel brightness in the picture disparity map comprises:

determining a disparity value of each pixel in the picture disparity map according to the pixel brightness in the picture disparity map; and

determining a pixel depth of a corresponding pixel in the target picture according to the disparity value of each pixel in the picture disparity map.

In the picture rendering method provided by the present invention, the step of acquiring a target image in the target picture, and dividing the target picture into a primary rendering region and a plurality of secondary rendering regions based on the pixel depth of the target picture and a target image depth of the target picture comprises:

determining the primary rendering region of the target picture based on the target image depth of the target picture;

determining at least one first secondary rendering region according to the maximum pixel depth of the target picture and the target image depth of the target picture; and

determining at least one second secondary rendering region according to the minimum pixel depth of the target picture and the target image depth of the target picture;

wherein each of the primary rendering region, the first secondary rendering regions and the second secondary rendering regions has a corresponding region depth range.

In the picture rendering method provided by the present invention, the step of determining at least one first secondary rendering region according to the maximum pixel depth of the target picture and the target image depth of the target picture comprises:

setting at least one first region image depth according to the maximum pixel depth and the target image depth, wherein the first region image depths are smaller than the maximum pixel depth and are greater than the target image depth; and

setting target picture regions, belonging to the first region image depths, as the corresponding first secondary rendering regions;

the step of determining at least one second secondary rendering region according to the minimum pixel depth of the target picture and the target image depth of the target picture comprises:

setting at least one second region image depth according to the minimum pixel depth and the target image depth, wherein the second region image depths are greater than the minimum pixel depth and are smaller than the target image depth; and

setting target picture regions, belonging to the second region image depths, as the corresponding second secondary rendering regions.

In the picture rendering method provided by the present invention, overlapping regions are arranged between the adjacent first secondary rendering regions, overlapping regions are arranged between the adjacent second secondary rendering regions, an overlapping region is arranged between the primary rendering region and the first secondary rendering region adjacent to the primary rendering region, and an overlapping region is arranged between the primary rendering region and the second secondary rendering region adjacent to the primary rendering region.

In the picture rendering method provided by the present invention, the overlapping region between the primary rendering region and the first secondary rendering region adjacent to the primary rendering region is greater than each overlapping region between the adjacent first secondary rendering regions; and the overlapping region between the primary rendering region and the second secondary rendering region adjacent to the primary rendering region is greater than each overlapping region between the adjacent second secondary rendering regions.

In the picture rendering method provided by the present invention, the step of performing picture rendering on the primary rendering region and the plurality of secondary rendering regions according to difference values of pixel depths corresponding to the secondary rendering regions and a pixel depth corresponding to the primary rendering region comprises:

performing picture rendering on the primary rendering region and the plurality of secondary rendering regions;

determining blurring coefficients corresponding to all the secondary rendering regions according to the difference values of the pixel depths corresponding to the secondary rendering regions and the pixel depth corresponding to the primary rendering region; and

performing blurring and defocusing on the corresponding secondary rendering regions based on the blurring coefficients corresponding to all the secondary rendering regions; wherein the blurring coefficients of the secondary rendering regions having greater difference values are greater.

In the picture rendering method provided by the present invention, overlapping regions are arranged between the adjacent rendering regions;

the step of synthesizing the picture-rendered primary rendering region and secondary rendering regions comprises:

performing picture smoothing on the target picture in the overlapping regions based on blurring and defocusing parameters for blurring and defocusing in the two rendering regions corresponding to the overlapping regions.

An embodiment of the present invention further provides a picture rendering apparatus, comprising:

a picture disparity map acquisition module, used for acquiring a target picture, and acquiring a picture disparity map of the target picture by using a stereo matching algorithm;

a pixel depth acquisition module, used for determining a pixel depth in the target picture according to a pixel brightness in the picture disparity map;

a rendering region division module, used for acquiring a target image in the target picture, and dividing the target picture into a primary rendering region and a plurality of secondary rendering regions based on the pixel depth of the target picture and a target image depth of the target picture;

a picture rendering module, used for performing picture rendering on the primary rendering region and the plurality of secondary rendering regions according to difference values of pixel depths corresponding to the secondary rendering regions and a pixel depth corresponding to the primary rendering region; and

a picture synthesis module, used for synthesizing the picture-rendered primary rendering region and secondary rendering regions to generate a rendered target picture.

An embodiment of the present invention further provides a computer readable storage medium, storing instructions executable by a processor, wherein the instructions are loaded by one or more processors so as to execute the above-mentioned picture rendering method.

An embodiment of the present invention further provides a terminal, comprising a processor and a memory, the memory stores a plurality of instructions, and the processor loads the instructions from the memory so as to execute the above-mentioned picture rendering method.

Compared with a picture rendering method and apparatus in the prior art, the picture rendering method and apparatus provided by the present invention lie in that picture rendering is performed based on the pixel depths of the secondary rendering regions and the pixel depth of the primary rendering region, so that better picture rendering can be performed on near objects and distant objects in a picture at the same time; and the technical problem of relatively poor picture rendering effect of a video picture frame having near objects and distant objects at the same time in an existing picture rendering method and apparatus is better solved.

### BRIEF DESCRIPTION OF THE DRAWINGS

FIG. 1 is a flowchart of a first embodiment of a picture rendering method provided by the present invention;

FIG. 2 is a flowchart of step S102 in the first embodiment of the picture rendering method provided by the present invention;

FIG. 3 is a schematic diagram of a picture disparity map in the first embodiment of the picture rendering method provided by the present invention;

FIG. 4 is a flowchart of step S103 in the first embodiment of the picture rendering method provided by the present invention;

FIG. 5 is a flowchart of step S104 in the first embodiment of the picture rendering method provided by the present invention;

FIG. 6a to FIG. 6c are schematic diagrams of a rendering effect in the first embodiment of the picture rendering method provided by the present invention;

FIG. 7 is a schematic diagram showing a structure in a first embodiment of a picture rendering apparatus provided by the present invention; and

FIG. 8 is a schematic diagram showing a structure of a working environment of an electronic device where the picture rendering apparatus provided by the present invention is located.

### DESCRIPTION OF THE EMBODIMENTS

Technical solutions in the embodiments of the present invention will be described clearly and completely below in conjunction with the accompanying drawings in the embodiments of the present invention. Obviously, the described embodiments are only a part of the embodiments of the present invention, not all the embodiments. Based on the embodiments in the present invention, all other embodiments obtained by those of ordinary skill in the art without creative work shall fall within the protective scope of the present invention.

The picture rendering method and apparatus provided by the present invention can be used in an electronic device for picture rendering of a video picture frame. The electronic device comprises, but is not limited to, a wearable device, a head-mounted device, a medical health platform, a personal computer, a server computer, a handheld or laptop device, a mobile device (such as a mobile phone, a personal digital assistant (PDA) and a media player), a multi-processor system, a consumer electronic device, a small-size computer, a large-scale computer, and a distributed computing environment comprising any of above-mentioned systems or devices. The electronic device is preferably a shooting terminal so that picture rendering can be performed on a video picture shot by the shooting terminal, and the shooting terminal can better perform picture rendering on distant objects and near objects in the video picture at the same time.

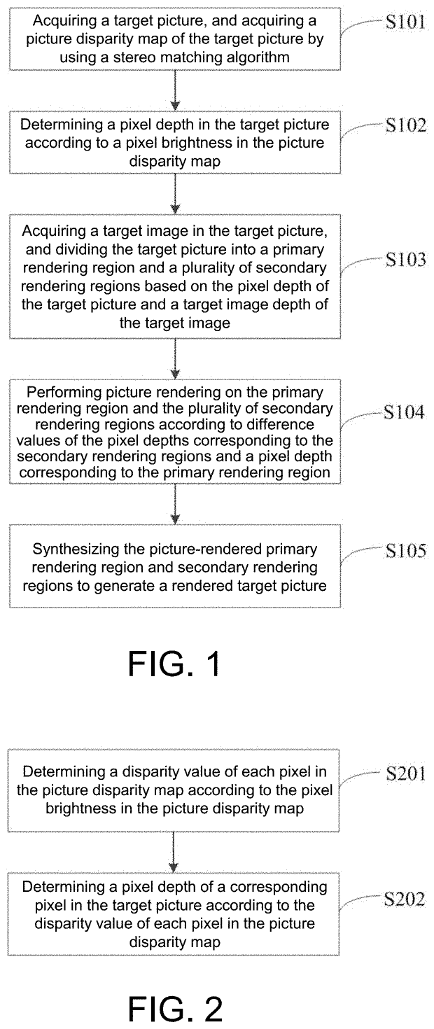

Referring to FIG. 1, FIG. 1 is a flowchart of a first embodiment of a picture rendering method provided by the present invention. The picture rendering method provided in the present embodiment can be implemented by using the above-mentioned electronic device. The picture rendering method comprises:

step S101, acquiring a target picture, and acquiring a picture disparity map of the target picture by using a stereo matching algorithm;

step S102, determining a pixel depth in the target picture according to a pixel brightness in the picture disparity map;

step S103, acquiring a target image in the target picture, and dividing the target picture into a primary rendering region and a plurality of secondary rendering regions based on the pixel depth of the target picture and a target image depth of the target picture;

step S104, performing picture rendering on the primary rendering region and the plurality of secondary rendering regions according to difference values of pixel depths corresponding to the secondary rendering regions and a pixel depth corresponding to the primary rendering region; and

step S105, synthesizing the picture-rendered primary rendering region and secondary rendering regions to generate a rendered target picture.

Specific processes of all the steps of the picture rendering method in the present preferred embodiment will be described in detail below.

In step S101, a picture rendering apparatus (an electronic device such as a shooting terminal) acquires a target picture requiring picture rendering. Image rendering described herein refers to a process of processing and converting three-dimensional radiosity in an image into a two-dimensional image. Therefore, three-dimensional distance information of pixels in the target picture and pixel depth information in the target picture are required to be acquired herein.

In the step, the picture rendering apparatus can acquire the picture disparity map of the target picture by using the stereo matching algorithm such as stereo processing by semiglobal matching and mutual information. The picture disparity map is an image reflecting the vision disparity of objects in the target picture in the eyes of a person. Generally, the smaller the depths of fields of the objects in the target picture are, that is, the closer the objects to a shooting device are when the picture is shot, the higher the pixel brightness in the corresponding picture disparity map is.

In step S102, the picture rendering apparatus determines the pixel depth in the target picture according to the pixel brightness in the picture disparity map acquired in step S101. Specifically, referring to FIG. 2, FIG. 2 is a flowchart of step S102 in the first embodiment of the picture rendering method provided by the present invention. Step S102 comprises the following steps.

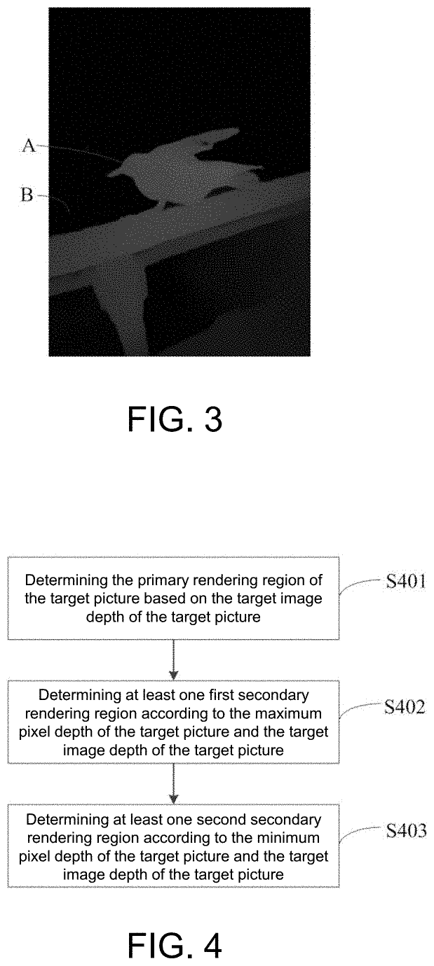

Step S201, the picture rendering apparatus determines a disparity value of each pixel in the picture disparity map according to the pixel brightness in the picture disparity map acquired in step S101. Referring to FIG. 3, wherein the pixel brightness in a region A is higher, and therefore, the disparity value of the pixel in the region A is greater; and the pixel brightness in a region B is lower, and therefore, the disparity value of the pixel in the region B is smaller.

Step S202, the picture rendering apparatus determines a pixel depth of a corresponding pixel in the target picture according to the disparity value of each pixel in the picture disparity map acquired in step S201. The pixel depth of the pixel described herein is inversely proportional to the disparity value of the pixel, that is, the disparity value of the pixel in the region A is greater, and therefore, the pixel depth of the pixel in the region A is smaller; and the disparity value of the pixel in the region B is smaller, and therefore, the pixel depth of the pixel in the region B is greater.

In step S103, the picture rendering apparatus acquires the target image in the target picture, wherein the target image described herein is an object image set by a user and required to be mainly displayed in the target picture. The pixel depth of the target image in the target picture becomes the target image depth.

In order to better display the target image, the picture rendering apparatus divides the target picture into a primary rendering region and a plurality of secondary rendering regions based on the pixel depth of the target picture and the target image depth of the target image in the target picture acquired in step S202. Referring to FIG. 4, FIG. 4 is a flowchart of step S103 in the first embodiment of the picture rendering method provided by the present invention. Step S103 comprises the following steps.

Step S401, the picture rendering apparatus determines the primary rendering region of the target picture based on the target image depth of the target picture acquired in step S202. That is, a region having the target image depth of the target picture is the primary rendering region of the target picture so that the target image can be better rendered. The picture rendering apparatus can set a region depth range of the primary rendering region according to the target image depth of the primary rendering region so that the primary rendering region can cover target picture regions within a certain depth range.

Step S402, the picture rendering apparatus acquires the maximum pixel depth of the target picture, and determines at least one first secondary rendering region according to the maximum pixel depth of the target picture and the target image depth of the target picture.

Specifically, the picture rendering apparatus can set at least one first region image depth according to the maximum pixel depth and the target image depth. The first region image depths are smaller than the maximum pixel depth and are greater than the target image depth. The picture rendering apparatus can uniformly set one or more first region image depths between the maximum pixel depth and the target image depth. For example, the maximum pixel depth is 100 m, the target image depth is 10 m, then, one first region image depth can be set on a position of 55 m; or two first region image depths can be set on positions of 40 m and 70 m.

Then, the picture rendering apparatus sets target picture regions, belonging to the first region image depths, as the corresponding first secondary rendering regions. For example, there are a plurality of first region image depths, then, a plurality of corresponding first secondary rendering regions are set.

The picture rendering apparatus can set a region depth range of the first secondary rendering regions according to the first region image depths of the first secondary rendering regions so that the first secondary rendering regions can cover target picture regions within a certain depth range.

Step S403, the picture rendering apparatus acquires the minimum pixel depth of the target picture, and determines at least one second secondary rendering region according to the minimum pixel depth of the target picture and the target image depth of the target picture.

Specifically, the picture rendering apparatus can set at least one second region image depth according to the minimum pixel depth and the target image depth. The second region image depths are greater than the minimum pixel depth and are smaller than the target image depth. The picture rendering apparatus can uniformly set one or more second image depths between the minimum pixel depth and the target image depth. For example, the minimum pixel depth is 1 m, the target image depth is 10 m, then, one second region image depth can be set on a position of 5.5 m; or two second region image depths can be set on positions of 4 m and 7 m.

Then, the picture rendering apparatus sets target picture regions, belonging to the second region image depths, as the corresponding second secondary rendering regions. For example, there are a plurality of second region image depths, then, a plurality of corresponding second secondary rendering regions are set.

The picture rendering apparatus can set a region depth range of the second secondary rendering regions according to the second region image depths of the second secondary rendering regions so that the second secondary rendering regions can cover target picture regions within a certain depth range.

In order to improve the rendering effect smoothness between the adjacent rendering regions, overlapping regions are arranged between the adjacent first secondary rendering regions, overlapping regions are arranged between the adjacent second secondary rendering regions, an overlapping region is arranged between the primary rendering region and the first secondary rendering region adjacent to the primary rendering region, and an overlapping region is arranged between the primary rendering region and the second secondary rendering region adjacent to the primary rendering region. In this way, the overlapping regions simultaneously have the rendering effects of the two adjacent rendering regions, so that the rendering effect smoothness between the adjacent rendering regions is better.

In order to enhance the picture rendering effect of the primary rendering region and the periphery thereof, the overlapping region between the primary rendering region and the first secondary rendering region adjacent to the primary rendering region is greater than each overlapping region between the adjacent first secondary rendering regions; and meanwhile, the overlapping region between the primary rendering region and the second secondary rendering region adjacent to the primary rendering region is greater than each overlapping region between the adjacent second secondary rendering regions. In this way, the rendering effect smoothness between the primary rendering region and the first secondary rendering region adjacent to the primary rendering region as well as between the primary rendering region and the second secondary rendering region adjacent to the primary rendering region is better, so that the display effect of a rendered picture in the primary rendering region concerned by a user is better.

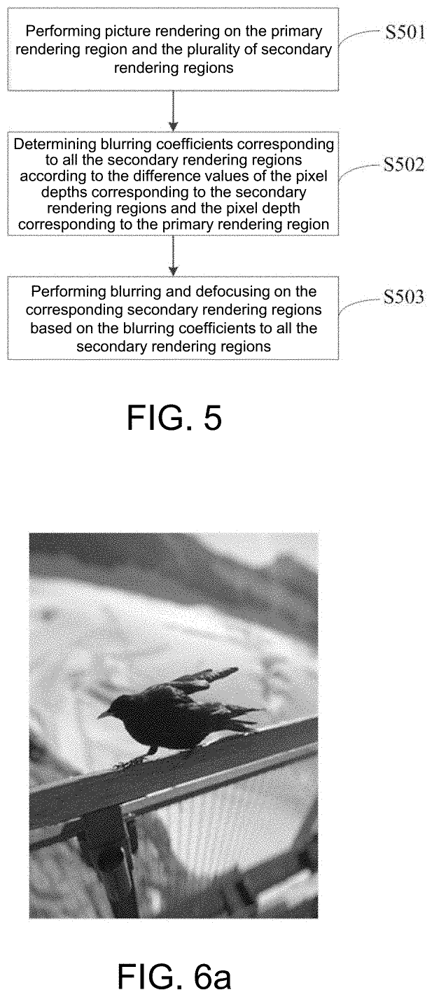

In step S104, the picture rendering apparatus performs picture rendering on the primary rendering region and the plurality of secondary rendering regions according to the difference values of the pixel depths corresponding to the secondary rendering regions and the pixel depth corresponding to the primary rendering region acquired in step S103. Specifically, referring to FIG. 5, FIG. 5 is a flowchart of step S104 in the first embodiment of the picture rendering method provided by the present invention. Step S104 comprises the following steps.

Step S501, the picture rendering apparatus respectively performs picture rendering on the primary rendering region and the plurality of secondary rendering regions.

Step S502, in order to further enhance the display effect of the primary rendering region, the secondary rendering regions are required to be blurred herein. For example, Gaussian blurring or mean blurring is performed on the secondary rendering regions, wherein a blurring coefficient during blurring is capable of reflecting the blurring level of a blurred image.

Since the blurring levels of the secondary rendering regions having greater pixel depth differences from the primary rendering region should be higher, a target image in the primary rendering region can be better displayed. Therefore, herein, the picture rendering apparatus determines blurring coefficients corresponding to all the secondary rendering regions according to the difference values of the pixel depths corresponding to the secondary rendering regions and the pixel depth corresponding to the primary rendering region. The greater the difference values of the pixel depths corresponding to the secondary rendering regions and the pixel depth corresponding to the primary rendering region are, the greater the blurring coefficients corresponding to the secondary rendering regions are.

Step S503, after the blurring coefficients of the secondary rendering regions are determined in step S502, the picture rendering apparatus performs blurring and defocusing on the corresponding secondary rendering regions based on the blurring coefficients so that the target image in the primary rendering region is better displayed.

In step S105, the picture rendering apparatus synthesizes the picture-rendered primary rendering region and secondary rendering regions in step S104 so as to generate the rendered target picture.

Specifically, the picture rendering apparatus can perform picture smoothing on the target picture in the overlapping regions of two rendering regions based on blurring and defocusing parameters for blurring and defocusing in the two rendering regions corresponding to the overlapping regions, so that the rendering effect smoothness between the adjacent rendering regions is better.

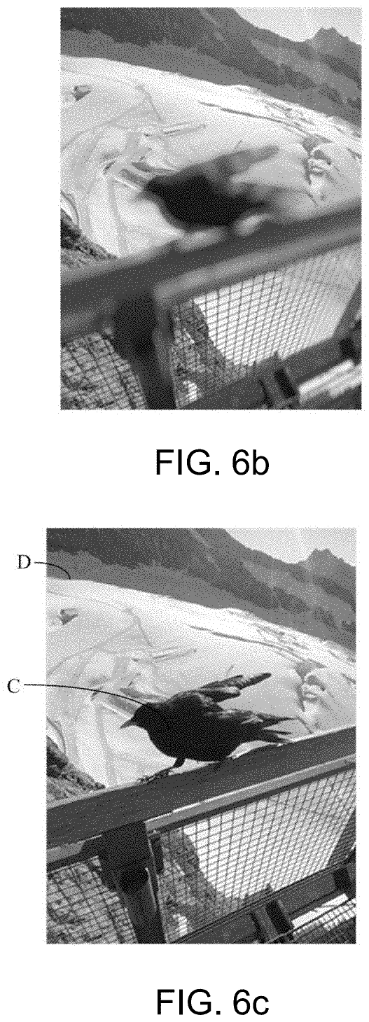

If a region C in FIG. 6c is the picture-rendered primary rendering region, the synthesized target picture is shown in FIG. 6a in which the target image in the center of the target picture can be better displayed; and if a region Din FIG. 6c is the picture-rendered primary rendering region, the synthesized target picture is shown in FIG. 6b in which the target image surrounding the target picture can be better displayed.

In this way, the picture rendering process of the picture rendering method in the present embodiment is completed.

According to the picture rendering method in the present embodiment, picture rendering is performed based on the pixel depths of the secondary rendering regions and the pixel depth of the primary rendering region, so that better picture rendering can be performed on near objects and distant objects in a picture at the same time.

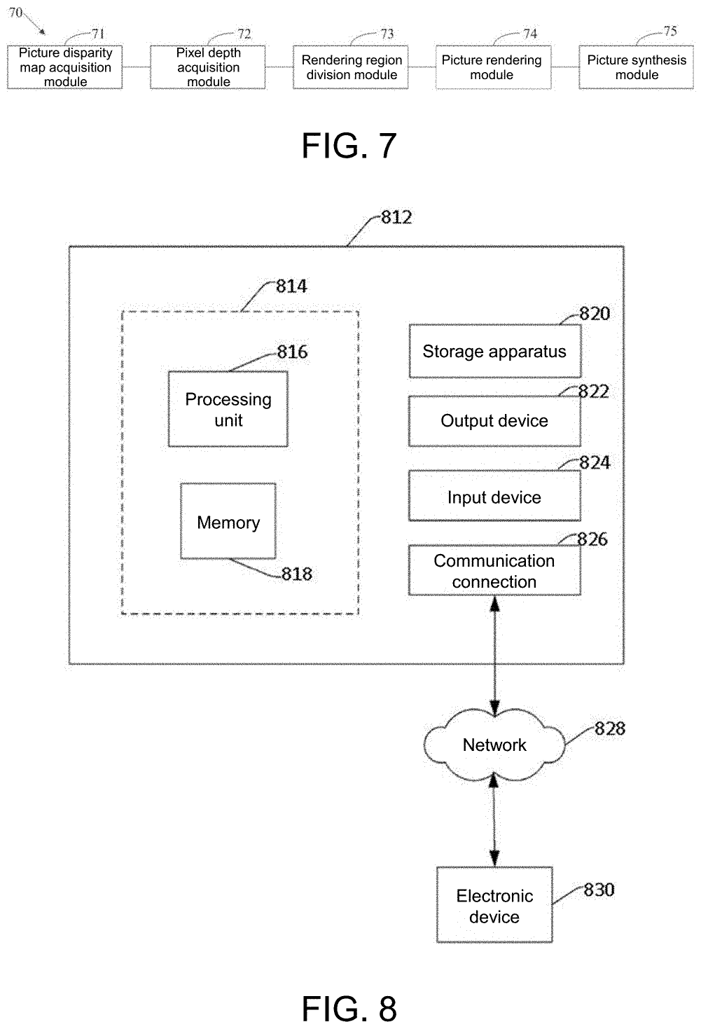

The present invention further provides a picture rendering apparatus, referring to FIG. 7 which is a schematic diagram showing a structure in a first embodiment of the picture rendering apparatus provided by the present invention. The picture rendering apparatus in the present embodiment can be implemented by using the above-mentioned picture rendering method. The picture rendering apparatus 70 comprises a picture disparity map acquisition module 71, a pixel depth acquisition module 72, a rendering region division module 73, a picture rendering module 74 and a picture synthesis module 75.

The picture disparity map acquisition module is used for acquiring a target picture, and acquiring a picture disparity map of the target picture by using a stereo matching algorithm; the pixel depth acquisition module is used for determining a pixel depth in the target picture according to a pixel brightness in the picture disparity map; the rendering region division module is used for acquiring a target image in the target picture, and dividing the target picture into a primary rendering region and a plurality of secondary rendering regions based on the pixel depth of the target picture and a target image depth of the target picture; the picture rendering module is used for performing picture rendering on the primary rendering region and the plurality of secondary rendering regions according to difference values of pixel depths corresponding to the secondary rendering regions and a pixel depth corresponding to the primary rendering region; and the picture synthesis module is used for synthesizing the picture-rendered primary rendering region and secondary rendering regions to generate a rendered target picture.

When the picture rendering apparatus in the present embodiment is used, firstly, the picture disparity map acquisition module acquires the target picture requiring picture rendering, and acquires the picture disparity map of the target picture by using the stereo matching algorithm. The picture disparity map is an image reflecting the vision disparity of objects in the target picture in the eyes of a person. Generally, the greater the difference of the depths of fields of the objects in the target picture is, the greater the difference of the pixel brightness in the corresponding picture disparity map is.

Then, the pixel depth acquisition module determines the pixel depth in the target picture according to the pixel brightness in the acquired picture disparity map.

Next, the rendering region division module acquires the target image in the target picture, wherein the target image described herein is an object image set by a user and required to be mainly displayed in the target picture. The pixel depth of the target image in the target picture becomes the target image depth. Moreover, the target picture is divided into the primary rendering region and the plurality of secondary rendering regions based on the acquired pixel depth of the target picture and the acquired target image depth of the target image in the target picture.

Next, the picture rendering module performs picture rendering on the primary rendering region and the plurality of secondary rendering regions according to the acquired difference values of the pixel depths corresponding to the secondary rendering regions and the pixel depth corresponding to the primary rendering region.

Finally, the picture synthesis module synthesizes the picture-rendered primary rendering region and secondary rendering regions to generate the rendered target picture.

In this way, the picture rendering process of the picture rendering apparatus in the present embodiment is completed.

A specific picture rendering process of the picture rendering apparatus in the present embodiment is the same with or similar to the description in the embodiment of the above-mentioned picture rendering method, specifically, please refer to relevant descriptions in the embodiment of the above-mentioned picture rendering method.

According to the picture rendering method and apparatus provided by the present invention, picture rendering is performed based on the pixel depths of the secondary rendering regions and the pixel depth of the primary rendering region, so that better picture rendering can be performed on near objects and distant objects in a picture at the same time; and the technical problem of relatively poor picture rendering effect of a video picture frame having near objects and distant objects at the same time in an existing picture rendering method and apparatus is better solved.

Terms such as “component”, “module”, “system”, “interface” and “process” used in the present application generally refer to computer-relevant entities: hardware, a combination of hardware and software, software or software being executed. For example, the component can be, but not limited to a process running on a processor, the processor, an object, an executable application, an executed thread, a program and/or a computer. Shown by the drawings, an application running on a controller and the controller can be both components. One or more components can exist in the executed process and/or thread and can be located on one computer and/or distributed between two computers or among more computers.

FIG. 8 and the subsequent discussion provide brief and general descriptions for a working environment of an electronic device where the picture rendering apparatus provided by the present invention is located. The working environment shown in FIG. 8 is only an example of an appropriate working environment and is not intended to constitute any limitations on the range of applications or functions of the working environment. An exemplary electronic device 812 comprises, but is not limited to, a wearable device, a head-mounted device, a medical health platform, a personal computer, a server computer, a handheld or laptop device, a mobile device (such as a mobile phone, a personal digital assistant (PDA) and a media player), a multi-processor system, a consumer electronic device, a small-size computer, a large-scale computer, and a distributed computing environment comprising any of above-mentioned systems or devices.

Although not required, the embodiment is described under the general background that “computer readable instructions” are executed by one or more electronic devices. The computer readable instructions can be distributed by a computer readable medium (discussed below). The computer readable instructions are implemented as program modules such as functions, objects, application programming interfaces (API) and data structures for executing specific tasks or implementing specific abstract data types. Typically, the functions of the computer readable instructions can be randomly combined or distributed in various environments.

FIG. 8 illustrates an example of an electronic device 812 comprising one or more embodiments of the picture rendering apparatus provided by the present invention. In one configuration, the electronic device 812 comprises at least one processing unit 816 and a memory 818. According to the exact configuration and type of the electronic device, the memory 818 can be a volatile memory (such as an RAM), a non-volatile memory (such as an ROM and a flash memory) or a certain combination of the volatile memory and the non-volatile memory. The configuration is shown as a dotted line 814 in FIG. 8.

In other embodiments, the electronic device 812 can comprise additional features and/or functions. For example, the device 812 can further comprise an additional storage apparatus (for example, removable and/or non-removable), and comprises, but is not limited to, a magnetic storage apparatus and an optical storage apparatus. The additional storage apparatus is illustrated as a storage apparatus 820 in FIG. 8. In one embodiment, the computer readable instructions for implementing one or more embodiments provided herein can be stored in the storage apparatus 820. The storage apparatus 820 can further store other computer readable instructions for implementing an operating system and an application. The computer readable instructions can be loaded into the memory 818 so as to be executed by, for example, the processing unit 816.

The term “computer readable medium” used herein comprises a computer storage medium. The computer storage medium comprises a volatile medium, a non-volatile medium, a removable medium and a non-removable medium implemented by using any method or technology for storing information such as the computer readable instructions or other data. The memory 818 and the storage apparatus 820 are examples of the computer storage medium. The computer storage medium comprises, but is not limited to, an RAM, an ROM, an EEPROM, a flash memory or other memory technologies, a CD-ROM, a digital video disk (DVD) or other optical storage apparatuses, a cassette tape, a magnetic tape, a magnetic disk storage apparatus or other magnetic storage devices, or any other media which can be used for storing desired information and can be accessed by the electronic device 812. Any of such computer storage media can be a part of the electronic device 812.

The electronic device 812 can further comprise a communication connection 826 allowing the electronic device 812 to communicate with other devices. The communication connection 826 can comprise, but not limited to, a modem, a network interface card (NIC), an integrated network interface, a radio frequency transmitter/receiver, an infrared port, a USB connection or other interfaces for connecting the electronic device 812 to other electronic devices. The communication connection 826 can comprise wired connection or wireless connection. The communication connection 826 is capable of transmitting and/or receiving a communication medium.

The term “computer readable medium” can comprise a communication medium. The communication medium typically comprises computer readable instructions or other data in “modulated data signals” such as carriers or other transmission mechanisms, and comprises any information delivery medium. The term “modulated data signals” can comprise such signals that one or more of signal features are set or changed in a manner of encoding information into the signals.

The electronic device 812 can comprise an input device 824 such as a keyboard, a mouse, a pen, a voice input device, a touch input device, an infrared camera, a video input device and/or any other input devices. The device 812 can further comprise an output device 822 such as one or more displays, loudspeakers, printers and/or any other output devices. The input device 824 and the output device 822 can be connected to the electronic device 812 by wired connection, wireless connection or any combination thereof. In one embodiment, an input device or an output device of another electronic device can be used as the input device 824 or the output device 822 of the electronic device 812.

Components of the electronic device 812 can be connected by various interconnections (such as a bus). Such interconnections can comprise a peripheral component interconnect (PCI) (such as a quick PCI), a universal serial bus (USB), a fire wire (IEEE 1394), an optical bus structure and the like. In another embodiment, the components of the electronic device 812 can be interconnected by a network. For example, the memory 818 can be composed of a plurality of physical memory units located on different physical positions and interconnected by the network.

It will be appreciated by those skilled in the art that storage devices for storing the computer readable instructions can be distributed across the network. For example, an electronic device 830 which can be accessed by a network 828 is capable of storing computer readable instructions for implementing one or more embodiments provided by the present invention. The electronic device 812 is capable of accessing the electronic device 830 and downloading a part or all of the computer readable instructions to be executed. Alternatively, the electronic device 812 is capable of downloading a plurality of computer readable instructions as required, or some instructions can be executed on the electronic device 812, and some instructions can be executed on the electronic device 830.

Various operations in the embodiments are provided herein. In one embodiment, the one or more operations can constitute one or more computer readable instructions stored in the computer readable medium, and a computing device will be enabled to execute the operations when the computer readable instructions are executed by the electronic device. The order of describing some or all of the operations should not be construed as implying that these operations have to be relevant to the order, and will be understood, by those skilled in the art, as an alternative order having benefits of this description. Moreover, it should be understood that not all the operations have to exist in each embodiment provided herein.

Moreover, although the present disclosure has been shown and described relative to one or more implementation modes, those skill in the art will envision equivalent variations and modifications based on reading and understanding of this description and the accompanying drawings. All of such modifications and variations are included in the present disclosure and are only limited by the scope of the appended claims. Particularly, with respect to various functions executed by the above-mentioned components (such as elements and resources), terms for describing such components are intended to correspond to any component (unless other indicated) for executing specified functions of the components (for example, the components are functionally equivalent), even if the structures of the components are different from the disclosed structures for executing the functions in an exemplary implementation mode of the present disclosure shown herein. In addition, although a specific feature in the present disclosure has been disclosed relative to only one in several implementation modes, the feature can be combined with one or more other features in other implementation modes which can be desired and beneficial for a given or specific application. Moreover, as for terms “comprising”, “having” and “containing” or variants thereof applied to the detailed description or claims, such terms means inclusion in a manner similar to the term “including”.

All the functional units in the embodiments of the present invention can be integrated in a processing module, or each unit separately and physically exists, or two or more units are integrated in a module. The above-mentioned integrated module can be achieved in a form of either hardware or a software functional module. If the integrated module is achieved in the form of the software functional module and is sold or used as an independent product, the integrated module can also be stored in a computer readable storage medium. The above-mentioned storage medium can be a read-only memory, a magnetic disk or an optical disk and the like. All of the above-mentioned apparatuses and systems can execute the methods in the corresponding embodiments of the methods.

In conclusion, although the present invention has been disclosed as above with the embodiments, serial numbers in front of the embodiments are merely used to facilitate description, rather than limit the order of the embodiments. Moreover, the above-mentioned embodiments are not intended to limit the present invention. Various changes and modifications can be made by those of ordinary skill in the art without departing from the spirit and scope of the present invention, and therefore, the protective scope of the present invention is subject to the scope defined by the claims.

What is claimed is:

1. A picture rendering method, comprising:
acquiring a target picture, and acquiring a picture disparity map of the target picture by using a stereo matching algorithm;
determining a pixel depth in the target picture according to a pixel brightness in the picture disparity map;
acquiring a target image in the target picture, and dividing the target picture into a primary rendering region and a plurality of secondary rendering regions based on the pixel depth of the target picture and a target image depth of the target picture;
performing picture rendering on the primary rendering region and the plurality of secondary rendering regions according to difference values of pixel depths corresponding to the plurality of secondary rendering regions and the pixel depth corresponding to the primary rendering region; and
synthesizing the picture-rendered primary rendering region and the plurality of picture-rendered secondary rendering regions to generate a rendered target picture.

2. The picture rendering method of claim 1, wherein the step of determining the pixel depth in the target picture according to the pixel brightness in the picture disparity map comprises:
determining a disparity value of each pixel in the picture disparity map according to the pixel brightness in the picture disparity map; and
determining the pixel depth corresponding the pixel in the target picture according to the disparity value of each pixel in the picture disparity map.

3. The picture rendering method of claim 1, wherein the step of acquiring the target image in the target picture, and dividing the target picture into the primary rendering region and the plurality of secondary rendering regions based on the pixel depth of the target picture and the target image depth of the target picture comprises:
determining the primary rendering region of the target picture based on the target image depth of the target picture;
determining at least one first secondary rendering region according to a maximum pixel depth of the target picture and the target image depth of the target picture; and
determining at least one second secondary rendering region according to a minimum pixel depth of the target picture and the target image depth of the target picture;
wherein each of the primary rendering region, the first secondary rendering regions and the second secondary rendering regions has a corresponding region depth range.

4. The picture rendering method of claim 3, wherein the step of determining the at least one first secondary rendering region according to the maximum pixel depth of the target picture and the target image depth of the target picture comprises:
setting at least one first region image depth according to the maximum pixel depth and the target image depth, wherein the first region image depths are smaller than the maximum pixel depth and are greater than the target image depth; and
setting target picture regions, belonging to the first region image depths, as the corresponding first secondary rendering regions;
the step of determining at least one second secondary rendering region according to the minimum pixel depth of the target picture and the target image depth of the target picture comprises:
setting at least one second region image depth according to the minimum pixel depth and the target image depth, wherein the second region image depths are greater than the minimum pixel depth and are smaller than the target image depth; and
setting the target picture regions, belonging to the second region image depths, as the corresponding second secondary rendering regions.

5. The picture rendering method of claim 4, wherein overlapping regions are arranged between the adjacent first secondary rendering regions, overlapping regions are arranged between the adjacent second secondary rendering regions, an overlapping region is arranged between the primary rendering region and the first secondary rendering region adjacent to the primary rendering region, and an overlapping region is arranged between the primary rendering region and the second secondary rendering region adjacent to the primary rendering region.

6. The picture rendering method of claim 5, wherein the overlapping region between the primary rendering region and the first secondary rendering region adjacent to the primary rendering region is greater than each overlapping region between the adjacent first secondary rendering regions; and the overlapping region between the primary rendering region and the second secondary rendering region adjacent to the primary rendering region is greater than each overlapping region between the adjacent second secondary rendering regions.

7. The picture rendering method of claim 1, wherein the step of performing picture rendering on the primary rendering region and the plurality of secondary rendering regions according to difference values of the pixel depths corresponding to the plurality of secondary rendering regions and the pixel depth corresponding to the primary rendering region comprises:
performing picture rendering on the primary rendering region and the plurality of secondary rendering regions;
determining blurring coefficients corresponding to all the secondary rendering regions according to the difference values of the pixel depths corresponding to the plurality of secondary rendering regions and the pixel depth corresponding to the primary rendering region; and
performing blurring and defocusing on the corresponding secondary rendering regions based on the blurring coefficients corresponding to all the secondary rendering regions; wherein the blurring coefficients of the plurality of secondary rendering regions having greater difference values are greater.

8. The picture rendering method of claim 1, wherein overlapping regions are arranged between the adjacent rendering regions, the step of synthesizing the picture-rendered primary rendering region and the plurality of picture-rendered secondary rendering regions comprises:
performing picture smoothing on the target picture in the overlapping regions based on blurring and defocusing parameters for blurring and defocusing in the two rendering regions corresponding to the overlapping regions.

9. A picture rendering apparatus, comprising:
a picture disparity map acquisition module, used for acquiring a target picture, and acquiring a picture disparity map of the target picture by using a stereo matching algorithm;
a pixel depth acquisition module, used for determining a pixel depth in the target picture according to a pixel brightness in the picture disparity map;
a rendering region division module, used for acquiring a target image in the target picture, and dividing the target picture into a primary rendering region and a plurality of secondary rendering regions based on the pixel depth of the target picture and a target image depth of the target picture;
a picture rendering module, used for performing picture rendering on the primary rendering region and the plurality of secondary rendering regions according to difference values of pixel depths corresponding to the plurality of secondary rendering regions and the pixel depth corresponding to the primary rendering region; and
a picture synthesis module, used for synthesizing the picture-rendered primary rendering region and the plurality of picture-rendered secondary rendering regions to generate a rendered target picture.

10. The picture rendering apparatus of claim 9, wherein the pixel depth acquisition module configured to:
determining a disparity value of each pixel in the picture disparity map according to the pixel brightness in the picture disparity map; and
determining the pixel depth corresponding the pixel in the target picture according to the disparity value of each pixel in the picture disparity map.

11. The picture rendering apparatus of claim 9, wherein the rendering region division module configured to:
determining the primary rendering region of the target picture based on the target image depth of the target picture;
determining at least one first secondary rendering region according to a maximum pixel depth of the target picture and the target image depth of the target picture; and
determining at least one second secondary rendering region according to a minimum pixel depth of the target picture and the target image depth of the target picture;
wherein each of the primary rendering region, the first secondary rendering regions and the second secondary rendering regions has a corresponding region depth range.

12. The picture rendering apparatus of claim 11, wherein the rendering region division module further configured to:
setting at least one first region image depth according to the maximum pixel depth and the target image depth, wherein the first region image depths are smaller than the maximum pixel depth and are greater than the target image depth; and
setting target picture regions, belonging to the first region image depths, as the corresponding first secondary rendering regions;
the step of determining at least one second secondary rendering region according to the minimum pixel depth of the target picture and the target image depth of the target picture comprises:
setting at least one second region image depth according to the minimum pixel depth and the target image depth, wherein the second region image depths are greater than the minimum pixel depth and are smaller than the target image depth; and
setting the target picture regions, belonging to the second region image depths, as the corresponding second secondary rendering regions.

13. The picture rendering apparatus of claim 12, wherein overlapping regions are arranged between the adjacent first secondary rendering regions, overlapping regions are arranged between the adjacent second secondary rendering regions, an overlapping region is arranged between the primary rendering region and the first secondary rendering region adjacent to the primary rendering region, and an overlapping region is arranged between the primary rendering region and the second secondary rendering region adjacent to the primary rendering region.

14. The picture rendering apparatus of claim 13, wherein the overlapping region between the primary rendering region and the first secondary rendering region adjacent to the primary rendering region is greater than each overlapping region between the adjacent first secondary rendering regions; and the overlapping region between the primary rendering region and the second secondary rendering region adjacent to the primary rendering region is greater than each overlapping region between the adjacent second secondary rendering regions.

15. The picture rendering apparatus of claim 9, wherein the picture rendering module configured to:
performing picture rendering on the primary rendering region and the plurality of secondary rendering regions;
determining blurring coefficients corresponding to all the secondary rendering regions according to the difference values of the pixel depths corresponding to the plurality of secondary rendering regions and the pixel depth corresponding to the primary rendering region; and
performing blurring and defocusing on the corresponding secondary rendering regions based on the blurring coefficients corresponding to all the secondary rendering regions; wherein the blurring coefficients of the plurality of secondary rendering regions having greater difference values are greater.

16. The picture rendering apparatus of claim 9, wherein overlapping regions are arranged between the adjacent rendering regions, the picture synthesis module configured to:
performing picture smoothing on the target picture in the overlapping regions based on blurring and defocusing parameters for blurring and defocusing in the two rendering regions corresponding to the overlapping regions.

17. A computer readable storage medium, storing instructions executable by a processor, wherein the processor executes the instructions to provide a picture rendering method comprising:
acquiring a target picture, and acquiring a picture disparity map of the target picture by using a stereo matching algorithm;
determining a pixel depth in the target picture according to a pixel brightness in the picture disparity map;
acquiring a target image in the target picture, and dividing the target picture into a primary rendering region and a plurality of secondary rendering regions based on the pixel depth of the target picture and a target image depth of the target picture;
performing picture rendering on the primary rendering region and the plurality of secondary rendering regions according to difference values of pixel depths corresponding to the plurality of secondary rendering regions and the pixel depth corresponding to the primary rendering region; and
synthesizing the picture-rendered primary rendering region and the plurality of picture-rendered secondary rendering regions to generate a rendered target picture.
